(19) United States
(12) Patent Application Publication
(10) Pub. No.: US 2019/0257383 A1
(43) Pub. Date: Aug. 22, 2019

(54) VIBRATION REDUCTION DEVICE

(71) Applicant: EXEDY CORPORATION, Neyagawa-shi, Osaka (JP)

(72) Inventors: Yuki KAWAHARA, Neyagawa-shi, Osaka (JP); Yusuke TOMITA, Neyagawa-shi, Osaka (JP); Yusuke OKAMOTO, Neyagawa-shi, Osaka (JP)

(73) Assignee: EXEDY Corporation, Neyagawa-shi, Osaka (JP)

(21) Appl. No.: 16/308,253

(22) PCT Filed: Jul. 27, 2017
(86) PCT No.: PCT/JP2017/027270

§ 371 Date: Dec. 7, 2018

(30) Foreign Application Priority Data
Aug. 24, 2016 (JP) 2016-163972

(51) Int. Cl. F16F 15/134; F16F 15/14; F16D 7/02

(52) U.S. Cl. CPC F16F 15/13469; F16D 7/025; F16F 15/145

(57) ABSTRACT

A vibration reduction device for reducing a torsional vibration from an engine includes an input rotary part, an output rotary part, a damper part, a dynamic vibration absorbing device, and a torque limiting part. Torsional vibration is input to the input rotary part. The output rotary part is disposed to be relatively rotatable with respect to the input rotary part. The damper part is disposed between the input rotary part and the output rotary part and attenuates the torsional vibration input to the input rotary part. The dynamic vibration absorbing device absorbs the torsional vibration output from the damper part. The torque limiting part limits transmission of torque between the input rotary part and the output rotary part.

### CROSS-REFERENCES TO RELATED APPLICATIONS

This application is the U.S. National Phase of PCT International Application No. PCT/JP2017/027270, filed on Jul. 27, 2017. That application claims priority to Japanese Patent Application No. 2016-163972, filed Aug. 24, 2016. The contents of both applications are herein incorporated by reference in their entirety.

### BACKGROUND

### Technical Field

The present disclosure relates to a vibration reduction device.

### Background Art

A conventional vibration reduction device is disposed between an engine and a transmission to reduce torsional vibration from the engine. The conventional vibration reduction device includes a housing (flywheel element 3), an output member (flywheel element 4), a damper part (energy accumulator 10) disposed radially outward, and a dynamic vibration absorbing device (vibration attenuator 10) that is disposed farther radially inward than the damper part.

### BRIEF SUMMARY

In the conventional vibration reduction device, when a torsional vibration from the engine is input to the housing, the torsional vibration is attenuated in the damper part. Also, the dynamic vibration absorbing device additionally attenuates the torsional vibration.

In this case, the period between after the start of the engine and until the rotational speed of the engine is stabilized, the rotational speed of the engine is unstable causing an excessive torque fluctuation to be input to the vibration reduction device from the engine, and therefore there is a risk that an excessive torsional vibration might occur in the vibration reduction device.

Also, after the rotational speed of the engine is stabilized, the operation of the dynamic damper device can cause a resonance, for example, a secondary resonance of the vibration reduction device to occur. Therefore, an excessive torsional vibration can occur in the vibration reduction device.

That is, when an excessive torsional vibration as described above occurs in the vibration reduction device, the vibration reduction device cannot completely absorb the torsional vibration, and therefore there is a risk that the torsional vibration might be transmitted from the vibration reduction device to a member on the transmission side.

The present disclosure has been made in view of the above problem, and an object of the present disclosure is to provide a vibration reduction device capable of operating appropriately and capable of stably attenuating a torsional vibration.

### Solution to Problem

(1) A vibration reduction device according to one aspect of the present disclosure is for reducing a torsional vibration from an engine. The vibration reduction device includes an input rotary part, an output rotary part, a damper part, a dynamic vibration absorbing device, and a torque limiting part. The torsional vibration is input to the input rotary part. The output rotary part is disposed so as to be relatively rotatable with respect to the input rotary part. The damper part is disposed between the input rotary part and the output rotary part, and attenuates the torsional vibration input to the input rotary part. The dynamic vibration absorbing device absorbs the torsional vibration output from the damper part. The torque limiting part limits the transmission of torque between the input rotary part and the output rotary part.

The present vibration reduction device is capable of blocking or suppressing the excessive torsional vibration that can occur in the vibration reduction device since the torque limiting part limits the transmission of torque between the input rotary part and the damper part. As a result, the vibration reduction device can be appropriately operated, and the torsional vibration can be stably attenuated in the vibration reduction device.

(2) In a vibration reduction device according to another aspect of the present disclosure, the input rotary part constitutes an internal space capable of containing lubricating oil. The damper part, the torque limiting part, and the dynamic vibration absorbing device are disposed in the internal space.

In this case, disposing the damper part, the torque limiting part, and the dynamic vibration absorbing device in the internal space of the input rotary part in a state where the lubricating oil is contained in the internal space of the input rotary part makes it possible to stably operate the damper part, the torque limiting part, and the dynamic vibration absorbing device.

(3) In a vibration reduction device according to yet another aspect of the present disclosure, the torque limiting part is disposed between the input rotary part and the damper part.

In this case, when excessive torsional vibration occurs in the vibration reduction device, torque transmission between the input rotary part and the damper part is substantially canceled by the torque limiting part. Therefore, the excessive torsional vibration that can occur in the vibration reduction device can be blocked or suppressed. That is, the vibration reduction device can be appropriately operated, and the torsional vibration can be stably attenuated in the vibration reduction device.

(4) In a vibration reduction device according to yet another aspect of the present disclosure, the torque limiting part includes a first coupling member, a second coupling member, a friction member, and a pressing member. The first coupling member is coupled to the input rotary part so as to be integrally rotatable therewith. The second coupling member is coupled to the damper part so as to be integrally rotatable therewith. The friction member is held between the first coupling member and the second coupling member.

With this configuration in which the torque limiting part is configured in this manner, the vibration reduction device can be appropriately operated, and the torsional vibration can be stably attenuated in the vibration reduction device.

(5) In a vibration reduction device according to yet another aspect of the present disclosure, the second coupling member is coupled to the damper part so as to be movable in a direction along a rotational axis of the input rotary part.

With this configuration in which the second coupling member of the torque limiting part is configured in this manner, the vibration reduction device can be appropriately operated, and the torsional vibration can be stably attenuated in the vibration reduction device.

(6) In a vibration reduction device according to yet another aspect of the present disclosure, the torque limiting part is disposed between the damper part and the output rotary part.

In this case, when excessive torsional vibration occurs in the vibration reduction device, torque transmission between the damper part and the output rotary part is substantially canceled by the torque limiting part. Therefore, the excessive torsional vibration that can occur in the vibration reduction device can be blocked or suppressed. That is, the vibration reduction device can be appropriately operated, and the torsional vibration can be stably attenuated in the vibration reduction device.

(7) In a vibration reduction device according to yet another aspect of the present disclosure, the torque limiting part includes a third coupling member and a second friction member. The third coupling member is disposed spaced apart from the output rotary part. The third coupling member is coupled to the output rotary part so as to be integrally rotatable therewith. The second friction member is held between the damper part and at least either the output rotary part or the third coupling member.

With this configuration in which the torque limiting part is configured in this manner, the vibration reduction device can be appropriately operated, and the torsional vibration can be stably attenuated in the vibration reduction device.

(8) In a vibration reduction device according to yet another aspect of the present disclosure, when the torque is less than a predetermined torque, the torque limiting part transmits torque between the input rotary part and the output rotary part. When the torque is equal to or greater than the predetermined torque, the torque limiting part substantially cancels the transmission of the torque between the input rotary part and the output rotary part.

In this case, when excessive torsional vibration occurs in the vibration reduction device, torque transmission between the input rotary part and the output rotary part is substantially canceled by the torque limiting part. Therefore, the excessive torsional vibration that can occur in the vibration reduction device can be blocked or suppressed. That is, the vibration reduction device can be appropriately operated, and the torsional vibration can be stably attenuated in the vibration reduction device.

(9) In a vibration reduction device according to yet another aspect of the present disclosure, the dynamic vibration absorbing device is disposed side by side with the damper part in a direction along a rotational axis of the input rotary part.

In this case, the dynamic vibration absorbing device can be effectively operated without receiving restrictions in the arrangement thereof due to the damper part. For example, it is possible to dispose the dynamic vibration absorbing device radially outward; thus allowing the dynamic vibration absorbing device to be effectively operated.

(10) In a vibration reduction device according to yet another aspect of the present disclosure, the damper part includes a first rotary member, a second rotary member, and a first elastic member. The first rotary member is coupled to the input rotary part. The second rotary member is disposed so as to be relatively rotatable with respect to the first rotary member. The second rotary member is coupled to the output rotary part. The first elastic member elastically couples the first rotary member and the second rotary member to each other.

Even if the damper part is configured in the manner now being exemplified, the vibration reduction device can be appropriately operated, and the torsional vibration can be stably attenuated in the vibration reduction device.

(11) In a vibration reduction device according to yet another aspect of the present disclosure, the dynamic vibration absorbing device includes an input member and an inertia mass body. The torsional vibration output from the damper part is input to the input member. The inertia mass body is configured to be relatively movable with respect to the input member.

Even if the dynamic vibration absorbing device is configured in the manner now being exemplified, the vibration reduction device can be appropriately operated, and the torsional vibration can be stably attenuated in the vibration reduction device.

(12) In a vibration reduction device according to yet another aspect of the present disclosure, the dynamic vibration absorbing device further includes a second elastic member that elastically couples the input member and the inertia mass body.

In this case, the inertia mass body is configured to be relatively movable with respect to the input member via the second elastic member. Even with such a configuration, the torsional vibration can be effectively absorbed in the dynamic vibration absorbing device.

(13) In a vibration reduction device according to yet another aspect of the present disclosure, each of the plurality of inertia mass bodies is pivotably supported by the input member with reference to a pivot center that is farther radially outward than the rotational axis of the input rotary part.

In this case, pivoting the inertia mass body with respect to the input member allows the torsional vibration to be effectively absorbed in the dynamic vibration absorber.

(14) In a vibration reduction device according to yet another aspect of the present disclosure, the dynamic vibration absorbing device further includes a centrifugal element. The centrifugal element engages with the inertia mass body by a centrifugal force. The centrifugal element guides the inertia mass body so that the relative displacement between the input member and the inertia mass body is reduced. Even with such a configuration, the torsional vibration can be effectively absorbed in the dynamic vibration absorbing device.

According to the present disclosure, the vibration reduction device can be appropriately operated, and it is possible to stably attenuate the torsional vibration in the vibration reduction device.

### BRIEF DESCRIPTION OF THE DRAWINGS

FIG. 1 is a cross-sectional configuration diagram of a vibration reduction device according to an exemplary embodiment of the present disclosure.

FIG. 2 is a diagram of a main damper device extracted from the vibration reduction device in FIG. 1.

FIG. 3 is a diagram of a torque limiter extracted from the vibration reduction device in FIG. 1.

FIG. 4 is a diagram of a dynamic damper device extracted from the vibration reduction device in FIG. 1.

FIG. 5 is a partial side view of a damper plate part of the dynamic damper device.

FIG. 6 is a partial side view of an inertia part of the dynamic damper device.

FIG. 7 is a partial side view of a lid member of the dynamic damper device.

FIG. 8 is a partial cross sectional view of the dynamic damper device.

FIG. 9A is a cross-sectional configuration diagram of a vibration reduction device according to another exemplary embodiment of the present disclosure.

FIG. 9B is an enlarged cross-sectional view of the torque limiter extracted from the vibration reduction device in FIG. 9A.

FIG. 10 is a partial side view of a dynamic damper device according to another exemplary embodiment of the present disclosure.

FIG. 11 is a partial side view of a dynamic damper device according to another exemplary embodiment of the present disclosure.

### DETAILED DESCRIPTION OF THE PREFERRED EMBODIMENTS

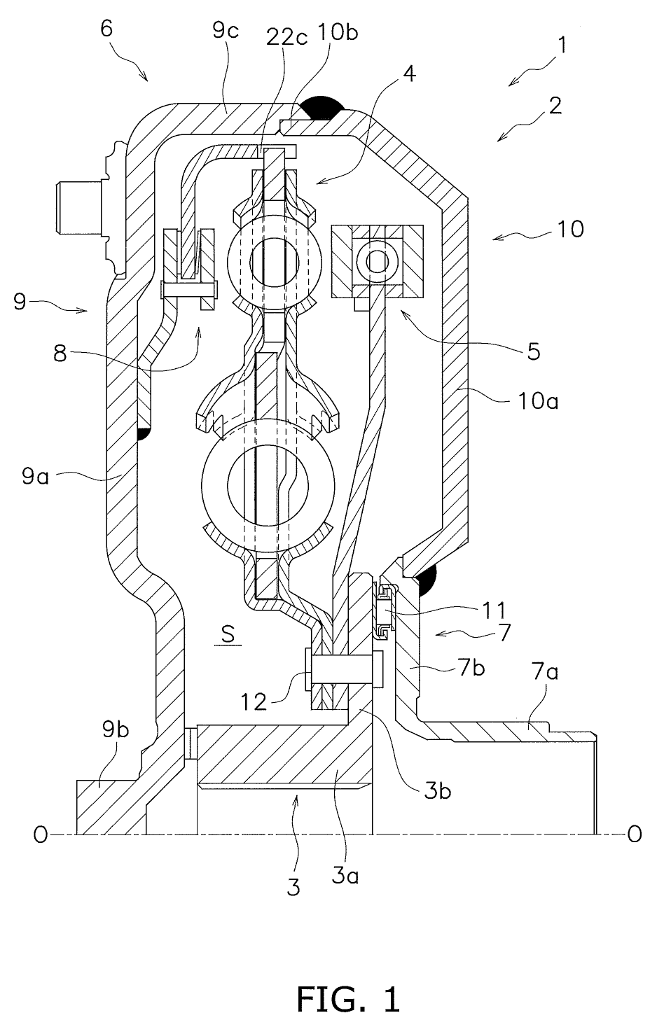

FIG. 1 is a cross-sectional view of a vibration reduction device according to an exemplary embodiment of the present disclosure. In FIG. 1, an engine (not shown in the drawing) is disposed on the left side whereas a transmission (not shown in the drawing) is disposed on the right side of the drawing. It should be noted that a line O-O depicted in FIG. 1 indicates a rotational axis of a vibration reduction device 1. It should also be noted that hereinafter, a direction away from the rotational axis O may be referred to as “radial direction”; a direction along the rotational axis O may be referred to as “axial direction”; and a direction around the rotational axis O may be referred to as “circumferential direction”.

[Overall Configuration of the Vibration Reduction Device]

The vibration reduction device 1 is a device for transmitting a torque from a member on the engine side to a member on the transmission side. Further, the vibration reduction device 1 is configured to be capable of reducing torsional vibration from the engine. The torsional vibration is a torsional vibration occurring in the vibration reduction device 1 due to torque fluctuation (rotation speed variation) input from the engine to the vibration reduction device 1.

As shown in FIG. 1, the vibration reduction device 1 includes a housing 2 (an example of an input rotary part), an output hub 3 (an example of an output rotary part), a main damper device 4 (an example of a damper part), a torque limiter 8 (torque limiting part), and a dynamic damper device 5 (an example of a dynamic vibration absorbing device).

<Housing>

A member on the engine side is attached to the housing 2, and the torque of the engine is input therein. As shown in FIG. 1, the housing 2 is configured to be rotatable around the rotational axis O.

The housing 2 includes a cover part 6 and a cover hub 7. The housing 2 constitutes an internal space S. The internal space S is configured to be capable of containing lubricating oil. In this case, the internal space S is formed by the cover part 6. It may be construed that the internal space S is formed by the cover part 6 and the cover hub 7. Furthermore, the interior space S may be construed as being formed by the housing 2 and the output hub 3.

(Cover Part)

The cover part 6 includes a first cover 9 and a second cover 10. The first cover 9 is a cover member on the engine side. The first cover 9 includes a first main body 9a, a boss part 9b, and a first outer peripheral cylindrical part 9c.

The first main body part 9a is formed in a substantially disc shape. The boss part 9b is provided on the inner peripheral part of the first main body part 9a. The boss part 9b protrudes from the inner peripheral part of the first main body part 9a toward the engine side. The boss part 9b is inserted into a crankshaft (not shown). The first outer peripheral cylindrical part 9c is provided on the outer peripheral part of the first main body part 9a. The first outer peripheral cylindrical part 9c protrudes from the outer peripheral part of the first main body part 9a toward the transmission side.

The second cover 10 is a cover member on the transmission side. The second cover 10 includes a second main body part 10a and a second outer peripheral cylindrical part 10b. The second main body part 10a is formed in a substantially annular shape. An inner peripheral part of the second main body part 10a is fixed to the cover hub 7 by welding. The second outer peripheral cylindrical part 10b is provided on the outer peripheral part of the second main body part 10a. The second outer peripheral cylindrical part 10b protrudes from the outer peripheral part of the second main body part 10a toward the engine side. The second outer peripheral cylindrical part 10b is fixed to the first outer peripheral cylindrical part 9c of the first cover 9 by welding.

<Hub for Cover>

The cover hub 7 is supported so as to be relatively rotatable with respect to the output hub 3. For example, the cover hub 7 is supported by the output hub 3 via a bearing or a thrust washer 11. It should be noted that the cover hub 7 may be construed as a member constituting the internal space S of the housing 2.

Specifically, the cover hub 7 includes a first hub main body 7a and a first hub flange 7b. The first hub main body 7a is formed in a substantially cylindrical shape. The first hub flange 7b is integrally formed with the first hub main body 7a. The first hub flange 7b protrudes radially outward from the outer peripheral part of the first hub body 7a. An inner peripheral part of the second main body part 10a of the second cover 10 is fixed to the first hub flange 7b by welding.

<Output Hub>

The output hub 3 is disposed so as be relatively rotatable with respect to the housing 2. As shown in FIG. 1, the output hub 3 is disposed in the internal space S of the housing 2. It should be noted that the output hub 3 may be construed as a member constituting the internal space S of the housing 2.

A member on the transmission side is attached to the output hub 3. The output hub 3 is mounted so as to be integrally rotatable with a shaft (not shown) on the transmission side.

Specifically, the output hub 3 includes a second hub main body 3a and a second hub flange 3b. The second hub main body 3a is substantially formed in a cylindrical shape. An inner peripheral part of the second hub main body 3a engages with the shaft of the transmission side so as to be integrally rotatable therewith. In this case, the inner peripheral part of the second hub main body 3a is spline-engaged with the outer peripheral part of the shaft on the transmission side.

The second hub flange 3b is integrally formed with the second hub main body 3a. The second hub flange 3b protrudes radially outward from an outer peripheral part of the second hub main body 3a. The main damper device 4 and the dynamic damper device 5 are fixed to the second hub flange 3b by fixing means, for example, a rivet 12. The above-described bearing or thrust washer 11 is disposed between the second hub flange 3b and the first hub flange 7b of the cover hub 7 in the axial direction.

<Main Damper Device>

The main damper device 4 attenuates the torsional vibration input into the housing 2. As shown in FIG. 1, the main damper device 4 is disposed in the internal space S of the housing 2.

The main damper device 4 is disposed closer to the engine side than the dynamic damper device 5 in the axial direction. In other words, the main damper device 4 is disposed between the engine and the dynamic damper device 5 in the axial direction. Specifically, the main damper device 4 is disposed between the housing 2 on the engine side and the dynamic damper 5 in the axial direction. More specifically, the main damper device 4 is disposed between the first cover 9 of the housing 2 and the dynamic damper device 5 in the axial direction.

The main damper device 4 couples the housing 2 and the output hub 3 to each other. The main damper device 4 is coupled to the housing 2 via the torque limiter 8. Further, the main damper device 4 is coupled to the output hub 3. For example, the main damper device 4 is fixed to the output hub 3 by fixing means such as the plurality of rivets 12.

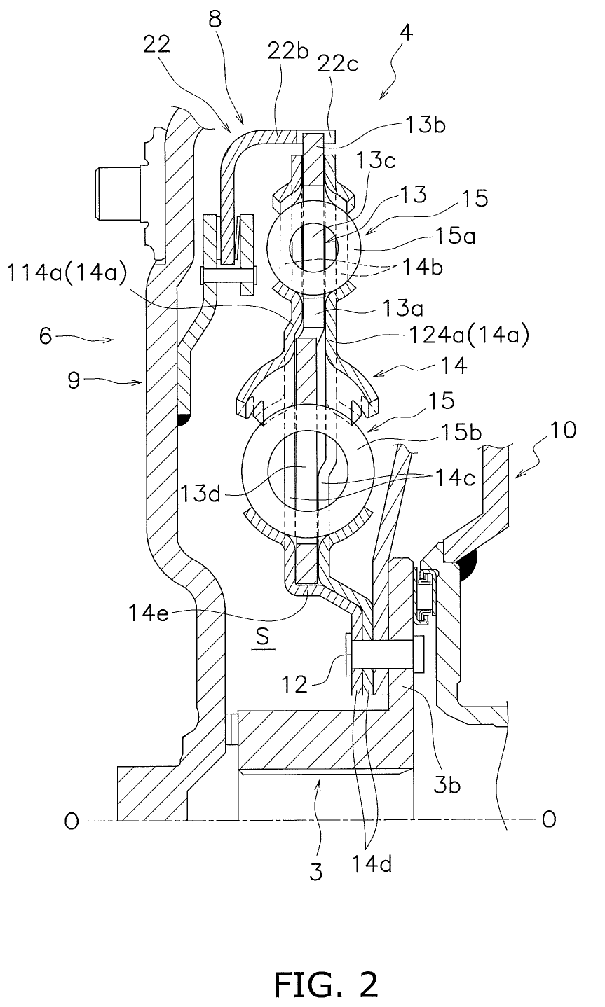

Specifically, as shown in FIG. 2, the main damper device 4 includes a drive plate 13 (an example of a first rotary member), a driven plate 14 (an example of a second rotary member), and a plurality of coil springs 15 (an example of a first elastic member).

(Drive Plate)

The drive plate 13 is rotatably disposed with respect to the driven plate 14. Further, the drive plate 13 is rotatably supported with respect to the driven plate 14.

As shown in FIG. 2, the drive plate 13 is coupled to the housing 2. In this case, the drive plate 13 is coupled to the cover part 6 of the housing 2 via the torque limiter 8.

Specifically, the drive plate 13 is configured to be integrally rotatable with a second coupling plate 22 (to be described later) of the torque limiter 8. In this case, the drive plate 13 is engaged with a third outer peripheral cylindrical part 22b (to be described later) of the second coupling plate 22 so as to be integrally rotatable with the second coupling plate 22.

In particular, the drive plate 13 includes a drive plate main body 13a, a plurality of engaging protrusions 13b, a plurality of first outer peripheral side window parts 13c (for example, four), and a plurality of inner peripheral side window parts 13d (for example, four).

The drive plate main body 13a is substantially annular and formed into a disc shape.

The plurality of engaging protrusions 13b are formed on an outer peripheral part of the drive plate main body 13a. Specifically, each of the plurality of engaging protrusions 13b protrudes radially outward from the outer peripheral part of the drive plate main body 13a. The plurality of engaging protrusions 13b are disposed at predetermined intervals in the circumferential direction. The plurality of engaging protrusions 13b are separately engaged with a plurality of engaging recess parts 22c (to be described later) of the third outer peripheral cylindrical part 22b of the second coupling plate 22. This configuration allows the drive plate 13 to rotate integrally with the second coupling plate 22.

The plurality of first outer peripheral side window parts 13c are provided on an outer peripheral side of the drive plate 13. Specifically, the first outer peripheral side window parts 13c are provided on the drive plate 13 at predetermined intervals in the circumferential direction. A plurality of outer peripheral side coil springs 15a (to be described later) are disposed in the first outer peripheral side window parts 13c respectively.

The plurality of first inner peripheral side window parts 13d are provided on an inner peripheral side of the drive plate 13. Specifically, the first inner peripheral side window parts 13d are provided on the drive plate 13 at predetermined intervals in the circumferential direction farther on the radially inner peripheral side than the plurality of first outer peripheral side window parts 13c. A plurality of inner peripheral side coil springs 15b (to be described later) are disposed in the first inner peripheral side window parts 13d respectively.

(Driven Plate)

The driven plate 14 is rotatably disposed with respect to the drive plate 13. As shown in FIG. 2, the driven plate 14 is coupled to the output hub 3.

The driven plate 14 includes a pair of driven plate bodies 14a, a plurality of second outer peripheral side window parts 14b, and a plurality of second inner peripheral side window parts 14c.

Each of the two driven plate bodies 14a is substantially annular and formed into a disc shape.

The pair of driven plate main bodies 14a is arranged facing each other in the axial direction. The drive plate 13 (drive plate main body 13a) is disposed between the pair of driven plate main bodies 14a in the axial direction. One of the driven plate main bodies 14a is disposed on the engine side with reference to the drive plate 13. The other driven plate 14 is disposed on the transmission side with reference to the drive plate 13.

Note that in the following description, one of the driven plate main bodies 14a may be referred to as a first driven plate main body 114a. In addition, the other driven plate main body 14a may be referred to as a second driven plate main body 124a.

More specifically, the inner peripheral parts of the first and second driven plate main bodies 114a and 124a (14a), for example, first fixing parts 14d are arranged adjacent to each other in the axial direction and fixed to the second hub flange 3b of the output hub 3 by fixing means, for example, the plurality of rivets 12. The first and second driven plate main bodies 114a and 124a (excluding the first fixing parts 14d) are disposed with a predetermined interval between each other in the axial direction. The drive plate 13 (drive plate main body 13a) is disposed in this interval. That is, the drive plate 13 is disposed between the first and second driven plate main bodies 114a and 124a (14a).

The first driven plate main body 114a is provided with a support part 14e for supporting the inner peripheral part of the drive plate 13 (drive plate main body 13a). The support part 14e is provided on the outer peripheral side of the first fixed part 14d of the first driven plate main body 114a. The support part 14e is formed in an annular shape. An inner peripheral part of the drive plate 13 (drive plate main body 13a) is disposed on an outer peripheral surface of the support part 14e. In this way, the first driven plate main body 114a positions the drive plate 13 (drive plate main body 13a) on the support part 14e in the radial direction.

The plurality of second outer peripheral side window parts 14b are provided on the outer peripheral sides of the pair of driven plate main bodies 14a (the first driven plate main body 114a and the second driven plate main body 124a), respectively. Specifically, each of the second outer peripheral side window parts 14b is provided in each of the two driven plate main bodies 14a at a predetermined interval in the circumferential direction. Each of the second outer peripheral side window parts 14b and each of the first outer peripheral side window parts 13c of the drive plate main body 13a are arranged to face each other in the axial direction. The plurality of outer peripheral side coil springs 15a (which will be described later) are each disposed in each of the second outer peripheral side window parts 14b and each of the first outer peripheral side window parts 13c.

The plurality of second inner peripheral side window parts 14c are provided on the inner peripheral sides of the pair of driven plate main bodies 14a (the first driven plate main body 114a and the second driven plate main body 124a), respectively. Specifically, each of the second inner peripheral side window parts 14c is provided in each of the two driven plate main bodies 14a at a predetermined interval in the circumferential direction. Each of the second inner peripheral side window parts 14c and each of the first inner peripheral side window parts 13d of the drive plate main body 13a are arranged to face each other in the axial direction. The plurality of inner peripheral side coil springs 15b (which will be described later) are each disposed in each of the second inner peripheral side window parts 14c and each of the first inner peripheral side window parts 13d.

(Coil Spring)

The plurality of coil springs 15 elastically couples the drive plate 13 and the driven plate 14 to each other. Specifically, the plurality of coil springs 15 include a plurality of outer peripheral side coil springs 15a (for example, four) and a plurality of inner peripheral side coil springs 15b (for example, four). With this configuration, the plurality of outer peripheral side coil springs 15a and the plurality of inner peripheral side coil springs 15b operate in parallel between the drive plate 13 and the driven plate 14.

Each of the plurality of outer peripheral side coil springs 15a elastically couples the drive plate 13 and the driven plate 14 to each other. The outer peripheral side coil springs 15a are respectively disposed onto the first outer peripheral side window parts 13c of the drive plate 13 and the second outer peripheral side window parts 14b of the driven plate 14.

The outer peripheral side coil springs 15a respectively abuts against both the first outer peripheral side window parts 13c and the second outer peripheral side window parts 14b in the circumferential direction. Specifically, each of the outer peripheral side coil springs 15a abuts against a wall part of each of the first outer peripheral side window parts 13c and a wall part of each of the second outer peripheral side window parts 14b. In addition, the cut-raised parts of the second outer peripheral side window parts 14b respectively prevent the outer peripheral side coil springs 15a from jumping out in the axial direction.

The plurality of inner peripheral side coil springs 15b each elastically couples the drive plate 13 and the driven plate 14 to each other. The inner peripheral side coil springs 15b are respectively disposed onto the first inner peripheral side window parts 13d of the drive plate 13 and the second inner peripheral side window parts 14c of the driven plate 14.

The inner peripheral side coil springs 15b respectively abut against the first inner peripheral side window parts 13d and the second inner peripheral side window parts 14c in the circumferential direction. Specifically, each of the inner peripheral side coil springs 15b abuts against a wall part of each of the first inner peripheral side window parts 13d and a wall part of each of the second inner peripheral side window parts 14c. In addition, the cut-raised parts of the second inner peripheral side window parts 14c respectively prevent the inner peripheral side coil springs 15b from jumping out in the axial direction.

Adopting a configuration that constitutes the plurality of coil springs 15 (the plurality of outer peripheral side coil springs 15a and the plurality of inner peripheral side coil springs 15b) allows at least a part of the plurality of coil springs 15 to be disposed side by side with an inertia part (to be described later) of the dynamic damper device 5 in the axial direction. For example, at least a part of the outer peripheral side coil springs 15a is disposed side by side with the inertia part in the axial direction. More specifically, a part of the outer peripheral side coil springs 15a is disposed side by side with the inertia part in the axial direction.

<Torque Limiter>

The torque limiter 8 limits the transmission of torque between the housing 2 and the output hub 3. In particular, the torque limiter 8 limits the transmission of torque between the housing 2 and the main damper device 4. More specifically, the torque limiter 8 limits the transmission of torque between the housing 2 and the main damper device 4 by frictional resistance.

As shown in FIG. 2, the torque limiter 8 is disposed in the internal space S of the housing 2. The torque limiter 8 is disposed between the housing 2 and the main damper device 4. Specifically, the torque limiter 8 is disposed between the housing 2 and the main damper device 4 in the axial direction. More specifically, the torque limiter 8 is disposed between the first cover 9 of the housing 2 and the drive plate 13 of the main damper device 4 in the axial direction.

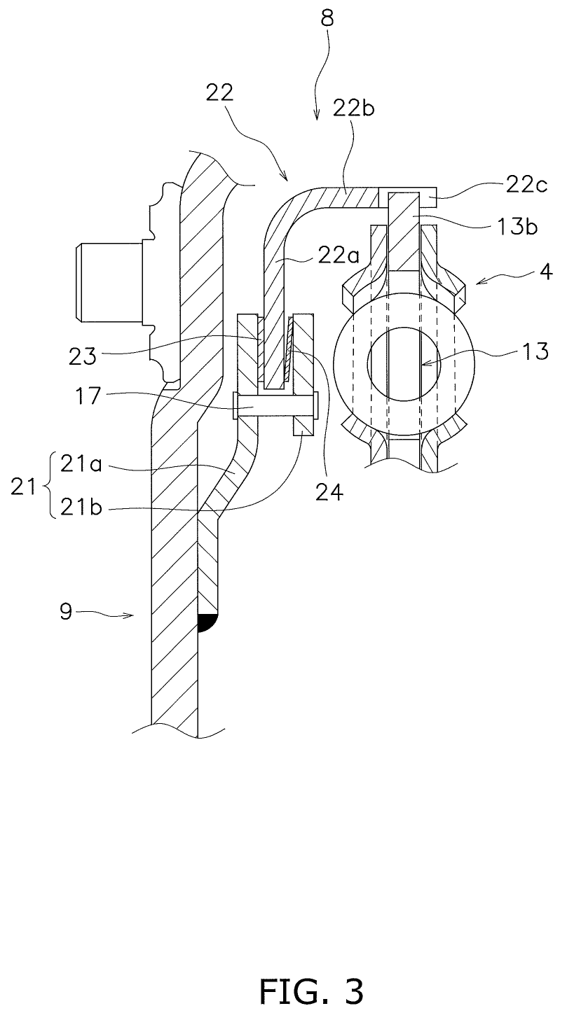

Specifically, as shown in FIG. 3, the torque limiter 8 includes a pair of first coupling plates 21 (an example of a first coupling member), the second coupling plate 22 (an example of a second coupling member), a friction member 23 (an example of a first friction member), and a cone spring 24.

The pair of first coupling plates 21 is coupled to the housing 2 so as to be integrally rotatable therewith. A first coupling plate 21a, which is one of the of first coupling plates 21, is fixed to the cover part 6. For example, the first coupling plate 21a is formed in a substantially annular shape. An inner peripheral part of the first coupling plate 21a is fixed to the cover part 6, for example, an inner surface of the first cover 9 by fixing means such as welding or riveting.

A first coupling plate 21b, which is the other of the of first coupling plates 21, is disposed at a predetermined interval with the first coupling plate 21a in the axial direction. For example, the first coupling plate 21b is formed in a substantially annular shape. The first coupling plate 21b is disposed at a predetermined interval with the first coupling plate 21a in the axial direction and is fixed to the first coupling plate 21a by fixing means such as a rivet 17.

The second coupling plate 22 is coupled to the pair of first coupling plates 21 via the friction member 23 and the cone spring 24. Specifically, the second coupling plate 22 includes a third main body part 22a and the third outer peripheral cylindrical part 22b. The third main body part 22a is formed in a substantially annular shape. The third main body part 22a is disposed between the pair of first coupling plates 21 in the axial direction.

The third outer peripheral cylindrical part 22b is provided on the outer peripheral part of the third main body part 22a. The third outer peripheral cylindrical part 22b protrudes from the outer peripheral part of the third main body part 22a toward the main damper device 4 side. A plurality of engaging recess parts 22c is formed at the distal end of the third peripheral cylindrical part 22b. Each of the plurality of engaging recess parts 22c opens in the axial direction. Each of the plurality of engaging recess parts 22c is disposed at predetermined intervals in the circumferential direction.

The plurality of engaging recess parts 22c are respectively engaged with the plurality of engaging protrusions 13b of the main damper device 4. More specifically, the plurality of engaging recess parts 22c are respectively engaged with the plurality of engaging protrusions 13b of the drive plate 13 so that the second coupling plate 22 is integrally rotatable with the drive plate 13. In addition, plurality of engaging recess parts 22c are respectively engaged with the plurality of engaging protrusions 13b of the drive plate 13 so that the second coupling plate 22 is movable in the axial direction with respect to the drive plate 13. With this configuration, the second coupling plate 22 is integrally rotatable with the drive plate 13 and movable in the axial direction with respect to the drive plate 13.

The friction member 23 is in contact with the first coupling plate 21 and the second coupling plate 22. Specifically, the friction member 23 is held between the first coupling plate 21 and the second coupling plate 22. In this state, when the first coupling plate 21 and the second coupling plate 22 rotate relative to each other, the friction member 23 slides with respect to at least one of either the first coupling plate 21 or the second coupling plate 22.

Specifically, the friction member 23 is disposed between the first coupling plate 21a and the second coupling plate 22 (the third main body 22a) in the axial direction, and is in contact with the first coupling plate 21a and the second coupling plate 22. The friction member 23 in this case is attached to the second coupling plate 22. The friction member 23 is in contact with the first coupling plate 21a and is slidable with respect to the first coupling plates 21a.

The cone spring is a pressing member that presses the second coupling plate. The cone spring 24 presses the second coupling plate 22 in order to bring the friction member 23 into contact with the first coupling plate 21 and the second coupling plate 22. The cone spring 24 is disposed between the first coupling plate 21b and the second coupling plate 22 (the third main body 22a) in the axial direction.

Specifically, the cone spring 24 is disposed between the other first coupling plate 21b and the second coupling plate 22 (the third main body 22a) in the axial direction in a compressed state. Due to the expansion force of the cone spring 24, the cone spring 24 presses the second coupling plate 22 toward the first coupling plate 21a. As a result, the friction member 23 is pressed against the first coupling plate 21a by the second coupling plate 22. In other words, the friction member 23 is clamped between the second coupling plate 22 and the first coupling plate 21a.

When a torque generated between the housing 2 and the main damper device 4 is less than the predetermined torque, the torque limiter 8 having the above configuration transmits the torque between the housing 2 and the main damper device 4.

In this case, the first coupling plate 21a and the second coupling plate 22 rotates integrally via the friction member 23. Specifically, the pair of first coupling plates 21 fixed to the housing 2 and the second coupling plate 22 coupled to the main damper device 4 (the drive plate 13) integrally rotate by the frictional resistance of the friction member 23. That is, in this case, the housing 2 and the drive plate 13 of the main damper device 4 integrally rotate via the torque limiter 8.

On the other hand, when the above described torque is equal to or greater than the predetermined torque, the torque limiter 8 substantially cancels the transmission of torque between the housing 2 and the main damper device 4.

In this case, the first coupling plate 21a and the friction members 23 attached to the second coupling plate 22 mutually slide in the circumferential direction. Then, the pair of first coupling plates 21 fixed to the housing 2 and the second coupling plate 22 coupled to the main damper device 4 (drive plate 13) relatively rotate with each other. That is, in this case, the housing 2 and the drive plate 13 of the main damper device 4 relatively rotate with each other via the torque limiter 8.

Note that the above-mentioned predetermined torque is determined by the frictional resistance between the first coupling plate 21a and the friction member 23. For example, the presence or absence of the aforementioned torque transmission in the torque limiter 8 is determined depending on the relationship between a rotational direction component of the torque generated between the housing 2 and the main damper device 4 and the frictional resistance between the first coupling plates 21 and the friction member 23.

<Dynamic Damper Device>

The dynamic damper device 5 absorbs torsional vibrations transmitted from the housing 2 to the main damper device 4. For example, when the torsional vibration of the engine is transmitted from the housing 2 to the main damper device 4, this torsional vibration is attenuated in the main damper device 4. Then, the torsional vibration output from the main damper device 4 is transmitted to the dynamic damper device 5. The dynamic damper device 5 absorbs this torsional vibration.

Note that the torsional vibration is vibration corresponding to a torque fluctuation (rotation speed variation). That is, the torsional vibration may include the meaning of torque fluctuation (rotation speed variation).

As shown in FIG. 1, the dynamic damper device 5 is disposed in the internal space S of the housing 2. The dynamic damper device 5 is disposed side by side with the main damper device 4 along the rotational axis O. In particular, the dynamic damper device 5 is disposed between the transmission and the main damper device 4 in the axial direction. More specifically, the dynamic damper device 5 is disposed between the second cover 10 of the housing 2 and the main damper device 4 in the axial direction.

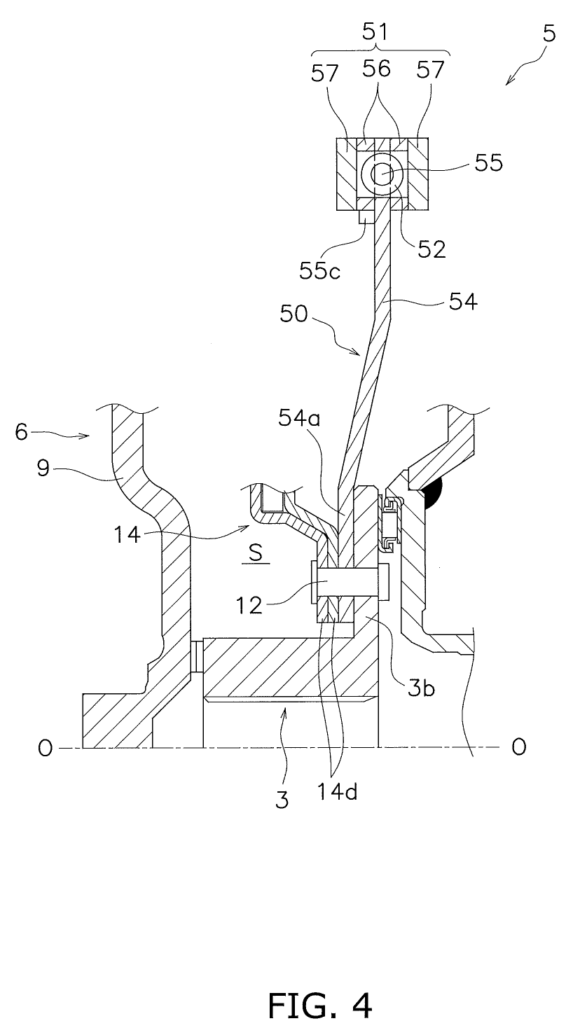

Specifically, as shown in FIG. 4, the dynamic damper device 5 includes a damper plate part 50 (an example of an input member), an inertia part 51 (an example of an inertia mass body), a plurality of damper springs 52 (for example, four; an example of a second elastic member), and a plurality of stop pins 53 (for example, eight).

(Damper Plate Part)

Torsional vibration output from the main damper device 4 is input to the damper plate part 50. In particular, as shown in FIG. 4, the torsional vibration output from the main damper device 4 (refer to FIG. 2) is input to the damper plate part 50 via the second hub flange 3b of the output hub 3.

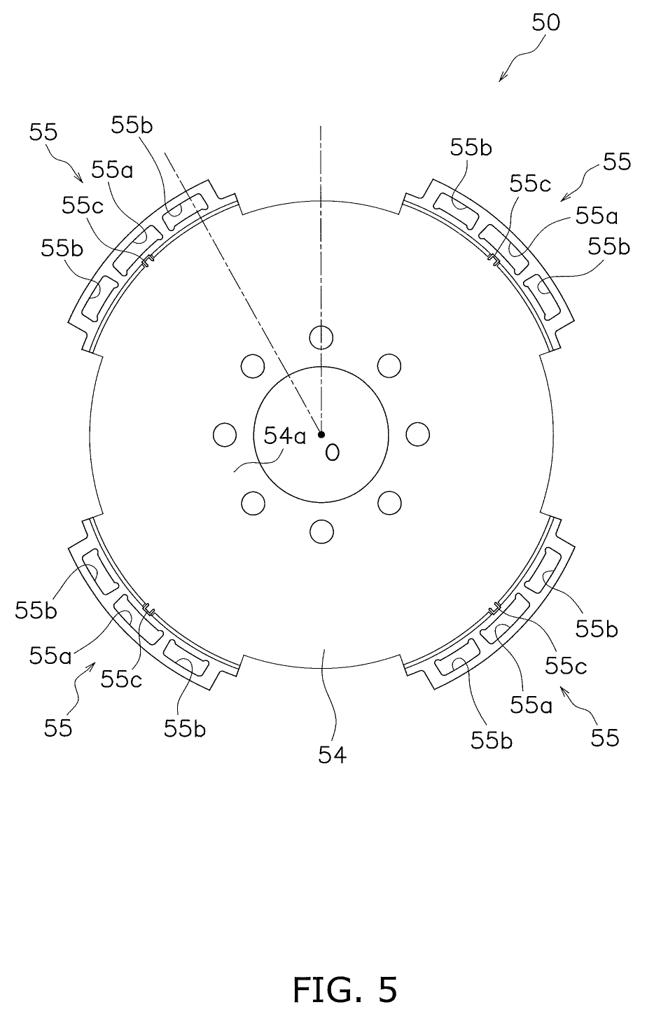

Specifically, as shown in FIGS. 4 and 5, the damper plate part 50 includes a damper plate main body 54 and a plurality of inertia engaging parts 55 (four, for example).

The damper plate main body 54 is formed in a substantially annular shape. An inner peripheral part of the damper plate main body 54, for example, a second fixing part 54a is fixed to the second hub flange 3b of the output hub 3 by fixing means, for example, the plurality of rivets 12. More specifically, the second fixing part 54a of the damper plate main body 54 is fixed to the second hub flange 3b of the output hub 3 together with the first fixing part 14d of the pair of driven plate main bodies 14a by the plurality of rivets 12.

The plurality of inertia engaging parts 55 are each integrally formed on the outer peripheral part of the damper plate main body 54. The plurality of inertia engaging parts 55 are each disposed on the outer peripheral part of the damper plate main body 54 at predetermined intervals in the circumferential direction. Each of the inertia engaging parts 55 protrudes radially outward from the outer peripheral part of the damper plate main body 54.

At least a part of each of the inertia engaging parts 55 is disposed side by side with the plurality of coil springs 15 of the main damper device 4 in the axial direction. For example, at least a part of the inertia engaging part 55 is disposed side by side with the outer peripheral side coil spring 15a in the axial direction. More specifically, a part of the inertia engaging part 55 is disposed side by side with the outer peripheral side coil spring 15a in the axial direction.

Each of the inertia engaging parts 55 includes a first spring storage part 55a, a plurality elongated holes 55b (for example, two), and a mate fitting part 55c.

Each of the first spring storage parts 55a is provided in each inertia engaging part 55 at predetermined intervals in the circumferential direction. Each of the first spring storage parts 55a is formed to have a predetermined length in the circumferential direction. Each of the damper springs 52 is disposed in each of the first spring storage parts 55a.

The plurality of elongated holes 55b is formed in each of the inertia engaging parts 55 on both sides of each of the first spring storage parts 55a in the circumferential direction. The plurality of elongated holes 55b has a predetermined length in the circumferential direction.

Each mate fitting part 55c is provided in each of the inertia engaging parts 55 on the inner side of the first spring storage part 55a in the radial direction. Each mate fitting part 55c is formed by cutting and raising a part of each of the inertia engaging parts 55.

(Inertia Part)

The inertia part 51 is configured to be relatively movable with respect to the damper plate part 50. Specifically, the inertia part 51 is configured to be relatively rotatable with respect the damper plate part 50.

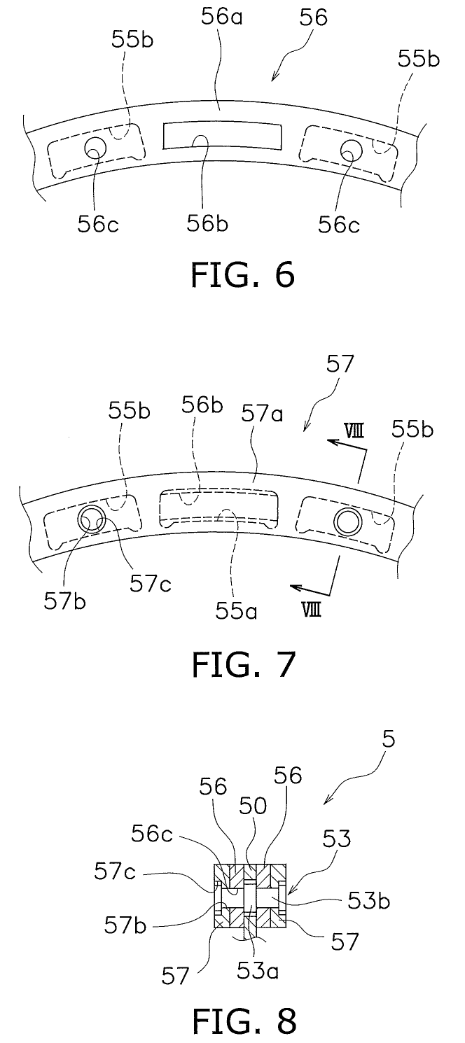

More specifically, as shown in FIGS. 4 and 6, the inertia part 51 includes a pair of inertia rings 56 and a pair of lid members 57.

The pair of inertia rings 56 is configured to be relatively rotatable with respect to the damper plate part 50. The inertia rings 56 are respectively disposed on both sides of the damper plate part 50 in the axial direction. The inertia rings 56 mutually have the substantially same configuration.

Each of the inertia rings 56 includes a ring main body 56a, a plurality of second spring storage parts 56b (for example, four in this case), and a plurality of first through holes 56c (for example, four in this case).

The ring main body 56a is formed in a substantially annular shape. The ring main body 56a is disposed on both sides of the inertia engaging part 55 in the axial direction. In addition, similar to the above-described inertia engaging parts 55, at least a part of the ring main body 56a is disposed side by side with the plurality of coil springs 15 of the main damper device 4 in the axial direction. For example, at least a part of the ring main body 56a is disposed side by side with the outer peripheral side coil spring 15a in the axial direction. More specifically, a part of the ring main body 56a is disposed side by side with the outer peripheral side coil spring 15a in the axial direction.

The second spring storage parts 56b are each provided in the ring main body 56a at predetermined intervals in the circumferential direction. Each of the second spring storage parts 56b is formed at a position corresponding to each of the first spring storage parts 55a of the damper plate part 50. The first through holes 56c are each formed in the ring body 56a at predetermined intervals in the circumferential direction. Each of the plurality of first through holes 56c is formed at a position corresponding to a center position in the circumferential direction inside each of the elongated holes 55b of the damper plate part 50.

The pair of lid members 57 is configured to be relatively rotatable with respect to the damper plate part 50 and integrally rotatable with the pair of inertia rings 56. As shown in FIG. 4, the lid members 57 are respectively disposed on both sides of the inertia rings 56 in the axial direction. The lid members 57 mutually have a substantially similar configuration.

Specifically, as shown in FIG. 7, the lid member 57 includes a lid body 57a, a second through hole 57b, and a third through hole 57c. The lid body 57a is formed in a substantially annular shape. The respective lid body 57a has inner and outer diameters that are the substantially same as the inner and outer diameters of the respective inertia rings 56 (ring main body 56a). The second through holes 57b are each formed in the lid main body 57a at predetermined intervals in the circumferential direction. Each of the second through holes 57b is formed at a position corresponding to each of the first through holes 56c of the inertia ring 56. Each of the third through holes 57c is formed coaxially with each of the second through holes 57b and larger in diameter than each of the second through holes 57b.

With this configuration in which the stop pins 53 are respectively inserted through the first through holes 56c of the inertia ring 56 and the second and third through holes 57b and 57c of the lid member 57, it is possible for the pair of lid members 57, together with the pair of inertia rings 56, to relatively rotate with respect to the damper plate unit 50. The structure of the respective stop pins 53 will be described later.

(Damper Spring)

As shown in FIG. 4, each of the plurality of damper springs 52 is, for example, the coil spring 15. The plurality of damper springs 52 are individually disposed in the first spring storage part 55a of the damper plate part 50 and the second spring storage part 56b of the inertia part 51. Both ends of each of the damper springs 52 respectively abut against wall parts of the first spring storage parts 55a and the second spring storage parts 56b in the circumferential direction. As a result, when the damper plate part 50 and the inertia part 51 rotate relative to each other, the damper springs 52 are compressed between the wall parts of the first spring storage part 55a and the wall parts of the second spring storage parts 56b in the circumferential direction.

(Stop Pin)

As shown in FIG. 8, each of the plurality of stop pins 53 includes a large-diameter shaft part 53a and a small-diameter shaft part 53b. The large-diameter shaft part 53a is provided on a center part of the stop pin 53 in the axial direction of the stop pin 53. The large-diameter shaft part 53a includes a diameter larger than a diameter of each of the first through holes 56c of the inertia ring 56 and also smaller than a diameter (a radial dimension) of each of the elongated holes 55b of the damper plate part 50.

The small-diameter shaft parts 53b are provided on both sides of the large-diameter shaft part 53a in the axial direction. Each of the small-diameter shaft parts 53b is inserted through each of the first through holes 56c of the inertia ring 56 and each of the second through holes 57b of the lid member 57. Fastening a head portion of the small-diameter shaft part 53b allows the head portion thereof to be disposed in each of the third through holes 57c. As a result, the inertia rings 56 and the lid members 57 are fixed axially to both sides of the damper plate part 50.

The above configuration allows the inertia part 51 (the inertia ring 56 and the lid member 57) to relatively rotate with respect to the damper plate part 50 in a range that the stop pin is movable in each of the elongated holes 55b of the damper plate part 50. When the large-diameter shaft part 53a of the stop pin 53 abuts against the end part of each of the elongated holes 55b, this abutment regulates the inertia part 51 (the inertia ring 56 and the lid member 57) from relatively rotating with respect to the damper plate part 50.

Further, in a state that the inertia part 51 (the inertia ring 56 and the lid member 57) is fixed by the stop pin 53, the inner peripheral surface of the inertia ring 56 abuts on the outer peripheral surface of the mate fitting part 55c of the damper plate part 50. With this configuration, the radial positioning of the inertia part 51 (the inertia ring 56 and the lid member 57) and the coil spring 15 is executed by the mate fitting part 55c.

<Operation of the Vibration Reduction Device>

When the torque of the engine is input to the housing 2, this torque is transmitted to the output hub 3 via the torque limiter 8 and the main damper device 4.

Specifically, the torque generated between the housing 2 and the main damper device 4 is limited by the torque limiter 8. For example, when the torque generated between the housing 2 and the main damper device 4 is less than the predetermined torque, the torque limiter 8 transmits the torque between the housing 2 and the main damper device 4. In this case, the housing 2 rotates integrally with the drive plate 13 of the main damper device 4.

Consequently, torque is transmitted between the housing 2 and the main damper device 4. Then, the torque is transmitted along a route and output to the output hub 3. The torque is then transmitted along the route of “the drive plate 13, the plurality of outer peripheral side coil springs 15a and the plurality of inner peripheral side coil springs 15b, and the driven plate 14” in the main damper device 4. Then, the torque is transmitted to a member on the transmission side via the output hub 3.

The main damper device 4 not only transmits the torque as described above but also attenuates the torsional vibration (torque fluctuation/rotation speed variation) input from the housing 2 via the torque limiter 8. Specifically, when torsional vibration is input to the main damper device 4, the outer peripheral coil springs 15a and the inner peripheral coil springs 15b are compressed between the drive plate 13 and the driven plate 14, whereby the torsional vibration input from the engine can be attenuated.

In addition, the output hub 3 is provided with the dynamic damper device 5 together with the main damper device 4. As a result, the dynamic damper device 5 can effectively suppress the torsional vibration (torque fluctuation/rotation speed variation) output from the main damper device 4.

For example, when the torsional vibration from the main damper device 4 is transmitted to the dynamic damper device 5, the inertia part 51 relatively rotates with respect to the damper plate part 50 via the plurality of damper springs 52. More specifically, the inertia part 51 rotates in a direction opposite to the rotation direction of the damper plate part 50 while the plurality of damper springs 52 are compressed and expanded by the input of the torsional fluctuation. That is, the inertia part 51 and the damper plate part 50 generate a phase difference in the rotation direction (circumferential direction). Due to the generation of the phase difference, the torsional vibration is absorbed by the dynamic damper device 5.

On the other hand, when the torque generated between the housing 2 and the main damper device 4 is equal to or greater than the predetermined torque, the torque limiter 8 cancels the transmission of torque between the housing 2 and the main damper device 4. In this case, the housing 2 and the drive plate 13 of the main damper device 4 rotate relative to each other. In this case, the main damper device 4 substantially does not operate.

When the vibration reduction device 1 operates as described above, if an absolute value of the torque fluctuation caused by the generation of the torsional vibration becomes equal to or greater than the predetermined torque, torque transmission between the housing 2 and the main damper device 4 is substantially interrupted by the torque limiter 8 even if an excessive torsional vibration is input to the housing 2. That is, even if an excessive torque fluctuation is input to the vibration reduction device 1, the torque limiter 8 prevents the excessive torque fluctuation from the housing 2 from being input to the main damper device 4. Consequently, each component of the vibration reduction device 1 can be appropriately operated, and the torsional vibration can be stably attenuated in each configuration of the vibration reduction device 1.

Further, the torque fluctuation generated between the housing 2 and the main damper device 4 increases at the resonance point of the vibration reduction device 1 (the main damper device 4 and the dynamic damper device 5), for example, in the vicinity of the secondary resonance point at the time of operation of the dynamic damper device 5.

However, when the absolute value of the torque fluctuation becomes equal to or greater than the above-mentioned predetermined torque, the torque transmission between the housing 2 and the main damper device 4 is substantially interrupted by the torque limiter 8. Thereby, the natural frequency (resonance point) of the vibration reduction device 1 changes, and the torsional vibration input to the dynamic damper device 5 decreases. As a result, the prevention of the occurrence of excessive torsional vibration in the vibration reduction device 1 is achieved. That is, at the resonance point of the vibration reduction device 1 and in the vicinity of the resonance point, each component of the vibration reduction device 1 can be appropriately operated and the torsional vibration can be stably attenuated in each configuration of the vibration reduction device 1.

<Summary>

The aforementioned exemplary embodiment can also be described as follows.

(1) The vibration reduction device 1 is a device for reducing torsional vibration from an engine. The vibration reduction device 1 includes the housing 2, the output hub 3, the main damper device 4, the dynamic damper device 5, and the torque limiter 8. Torsional vibration is input to the housing 2. The output hub 3 is disposed so as to be relatively rotatable with respect to the housing 2. The main damper device 4 is disposed between the housing 2 and the output hub 3, and attenuates the torsional vibration input to the housing 2. The dynamic damper device 5 absorbs the torsional vibration output from the main damper device 4. The torque limiter 8 is disposed between the housing 2 and the output hub 3, and limits the transmission of torque between the housing 2 and the output hub 3.

The present vibration reduction device 1 is capable of blocking or suppressing the excessive torsional vibration that can occur in the vibration reduction device 1 since the torque limiter 8 restricts the transmission of torque generated between the housing 2 and the main damper device 4. As a result, the vibration reduction device 1 can be appropriately operated, and the torsional vibration can be stably attenuated in the vibration reduction device 1.

(2) In the vibration reduction device 1, the housing 2 constitutes the internal space S capable of containing lubricating oil. The main damper 4, the torque limiter 8, and the dynamic damper device 5 are disposed in the internal space S.

In this case, disposing the main damper device 4, the torque limiter 8, and the dynamic damper device 5 in the internal space S of the housing 2 in the state in which the lubricating oil is contained in the internal space S of the housing 2 makes it possible to stably operate the main damper device 4, the torque limiter 8, and the dynamic damper device 5.

(3) In the vibration reduction device 1, the torque limiter 8 is disposed between the housing 2 and the main damper device 4.

In this case, when excessive torsional vibration occurs in the vibration reduction device 1, torque transmission between the housing 2 and the main damper device 4 is substantially canceled by the torque limiter 8. Therefore, the excessive torsional vibration that can occur in the vibration reduction device 1 can be blocked or suppressed. That is, the vibration reduction device 1 can be appropriately operated, and the torsional vibration can be stably attenuated in the vibration reduction device 1.

(4) In the vibration reduction device 1, the torque limiter 8 includes the first coupling plate 21, the second coupling plate 22, and the friction member 23. The first coupling plate 21 is integrally and rotatably coupled to the housing 2. The second coupling plate 22 is integrally and rotatably coupled to the main damper device 4. The friction member 23 is held between the first coupling plate 21 and the second coupling plate 22.

With this configuration in which the torque limiter 8 is configured in this manner, the vibration reduction device 1 can be appropriately operated, and the torsional vibration can be stably attenuated in the vibration reduction device 1.

(5) In the vibration reducing device 1, the second coupling plate 22 is coupled to the main damper device 4 so as to be movable in the axial direction.

With this configuration in which the second coupling plate 22 of the torque limiter 8 is configured in this manner, the vibration reduction device 1 can be appropriately operated, and the torsional vibration can be stably attenuated in the vibration reduction device 1.

(6) In the vibration reduction device 1, when the torque is less than the predetermined torque, the torque limiter 8 transmits the torque between the housing 2 and the main damper device 4. When the torque is equal to or greater than the predetermined torque, the torque limiter 8 substantially cancels the transmission of torque between the housing 2 and the main damper device 4.

In this case, when excessive torsional vibration occurs in the vibration reduction device 1, torque transmission between the housing 2 and the main damper device 4 is substantially canceled by the torque limiter 8. Therefore, the excessive torsional vibration that can occur in the vibration reduction device 1 can be blocked or suppressed. That is, the vibration reduction device 1 can be appropriately operated, and the torsional vibration can be stably attenuated in the vibration reduction device 1.

(7) In the vibration reduction device 1, the dynamic damper device 5 is disposed side by side with the main damper device 4 in the axial direction.

In this case, the dynamic damper device 5 can be effectively operated since the dynamic damper device 5 does not receive restrictions in the arrangement thereof due to the main damper 4. For example, it is possible to dispose the dynamic damper device 5 radially outward; thus allowing the dynamic damper device 5 to be effectively operated.

(8) In the vibration reduction device 1, the main damper device 4 includes the drive plate 13, the driven plate 14, and at least one coil spring 15. The drive plate 13 is coupled to the housing 2. The driven plate 14 is disposed so as to be relatively rotatable with respect to the drive plate 13. The driven plate 14 is coupled to the output hub 3. At least one coil spring 15 elastically couples the drive plate 13 and the driven plate 14 to each other.

Even if the main damper device 4 is constituted in the manner now being exemplified, the vibration reduction device 1 can be appropriately operated, and the torsional vibration can be stably attenuated in the vibration reduction device 1.

(9) In the vibration reduction device 1, the dynamic damper device 5 includes the damper plate part 50, the inertia part 51, and at least one damper spring 52. Torsional vibration output from the main damper device 4 is input to the damper plate part 50. The inertia part 51 is configured to be relatively movable with respect to the damper plate part 50. At least one damper spring 52 elastically couples the damper plate part 50 and the inertia part 51 with each other.

Even if the dynamic damper device 5 is configured in the manner now being exemplified, the vibration reduction device 1 can be appropriately operated and the torsional vibration can be stably attenuated in the vibration reduction device 1.

### Other Exemplary Embodiments

The present disclosure is not limited to the exemplary embodiment described above, and a variety of changes and modifications can be made herein without departing from the scope of the disclosure.

(a) In the aforementioned exemplary embodiment, the exemplified case is that the friction member 23 is disposed between the first coupling plate 21a and the second coupling plate 22 in the axial direction, and the cone spring 24 is disposed between the other first coupling plate 21b and the second coupling plate 22 in the axial direction. Alternatively, the cone spring 24 can be disposed between the first coupling plate 21a and the second coupling plate 22 in the axial direction, and the friction member 23 can be disposed between the other first coupling plate 21b and the second coupling plate 22 in the axial direction.

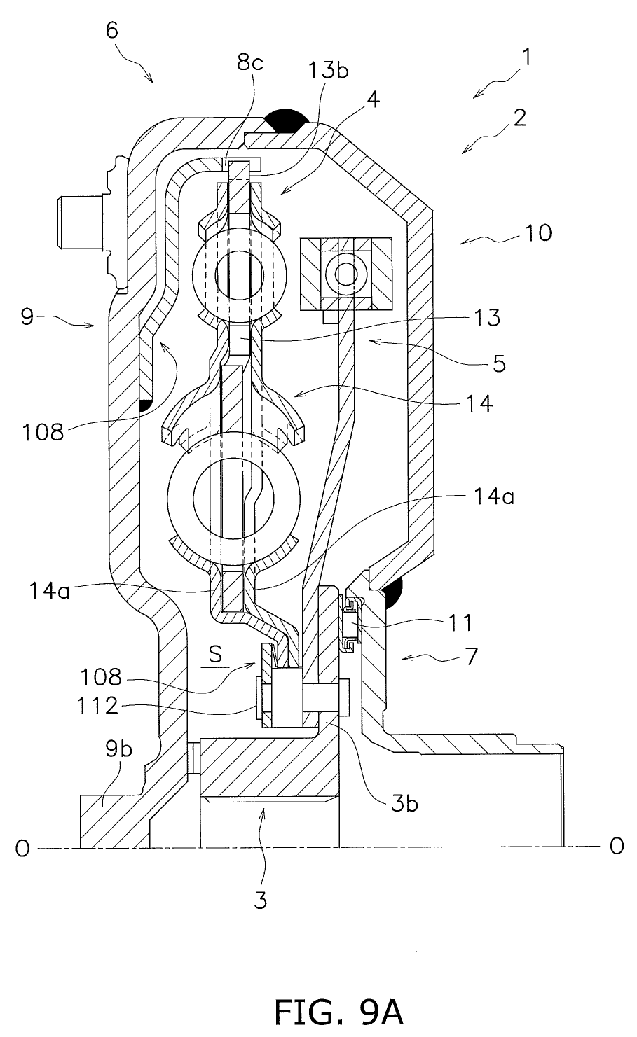

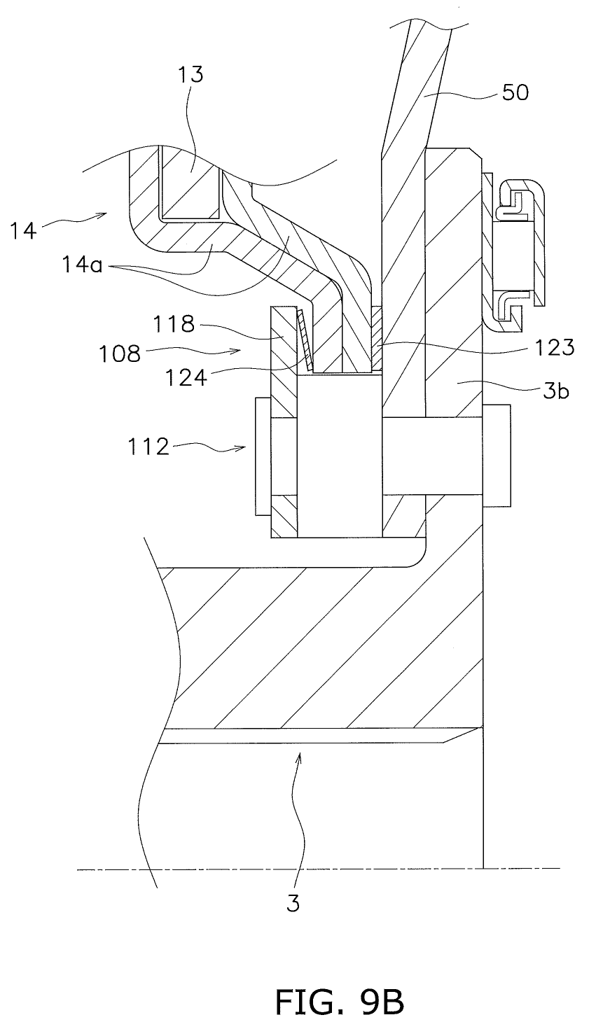

(b) In the aforementioned exemplary embodiment, the exemplified case is that the torque limiter 8 is disposed between the housing 2 and the main damper device 4. Alternatively, as shown in FIGS. 9A and 9B, a torque limiter 108 can be disposed between the main damper device 4 and the output hub 3. It should be noted that in FIGS. 9A and 9B, the same reference numerals are assigned to the same configurations as those in the above exemplary embodiment.

In this case, as shown in FIG. 9A, the main damper device 4, for example the drive plate 13, is coupled to the housing 2 (the first cover part 9) via a third coupling plate 108. The third coupling plate 108 couples the housing 2 and the main damper device 4. The third coupling plate 108 is fixed to the housing 2 and engages with the main damper device 4. For example, the third coupling plate 108 is engaged with the main damper device 4 in the same engaging form as the engaging form of the plurality of engaging recess parts 8c and the plurality of engaging protrusions 13b in the above exemplary embodiment.

The inner peripheral part of the main damper device 4, for example, the driven plate 14 (the pair of driven plate main bodies 14a) is disposed radially outward of a fixing member, for example, a stud pin 112. Note that the inner peripheral part of the driven plate 14 is not fixed to the output hub 3 (the second hub flange 3b).

The torque limiter 108 limits the transmission of torque between the main damper device 4 and the output hub 3. Specifically, the torque limiter 108 limits the transmission of torque between the main damper device 4 and the output hub 3 by frictional resistance.

Specifically, as shown in FIG. 9B, the torque limiter 108 includes a fourth coupling plate 118 (an example of the third coupling member), a friction member 123 (an example of the second friction member), and a cone spring 124.

The fourth coupling plate 118 is disposed spaced apart from the second hub flange 3b of the output hub 3 in the axial direction. The fourth coupling plate 118 is coupled to the second hub flange 3b so as to be rotatable integrally therewith. Specifically, the fourth coupling plate 118 is fixed to the second hub flange 3b by the stud pin 112. Note that in this case, the stud pin 112 also plays a role as a member for fixing the inner peripheral part of the damper plate part 50 of the dynamic damper device 5 to the second hub flange 3b.

An inner peripheral part of the driven plate 14 is disposed between the fourth coupling plate 118 and the second hub flange 3b in the axial direction. More specifically, the inner peripheral part of the driven plate 14 is disposed between the inner peripheral part of the fourth coupling plate 118 and the damper plate part 50 in the axial direction.

A cone spring 124 is disposed between the inner peripheral parts of the fourth coupling plate 118 and the driven plate 14 in the axial direction. The cone spring 124 urges the inner peripheral part of the driven plate 14 toward the second hub flange 3b (damper plate part 50).

The friction member 123 is disposed between the inner peripheral part of the driven plate 14 and the second hub flange 3b in the axial direction. In this case, the friction member 123 is attached to the inner peripheral part of the driven plate 14, and is disposed between the inner peripheral part of the driven plate 14 and the inner peripheral part of the damper plate part 50 in the axial direction. With this configuration, the friction member 123 is held between the inner peripheral part of the driven plate 14 and the second hub flange 3b via the inner peripheral part of the damper plate part 50.

Even if the torque limiter 108 is configured in this manner, similar to the above exemplary embodiment, each component of the vibration reduction device can be appropriately operated and the torsional vibration can be stably attenuated in each configuration of the vibration reduction device.

Note that the friction member 123 can be disposed between the inner peripheral parts of the fourth coupling plate 118 and the driven plate 14 in the axial direction, and the cone spring 124 can be disposed between the inner peripheral part of the driven plate 14 and the second hub flange 3b (the inner peripheral part of damper plate part 50) in the axial direction.

(c) In the aforementioned exemplary embodiment, the exemplified case is that the main damper device 4 is disposed closer to the engine side than the dynamic damper device 5 in the axial direction. Alternatively, the dynamic damper device 5 can be disposed closer to the engine side than the main damper device 4 in the axial direction.

In this case, the torque limiter 8 couples the main damper device 4 and the second cover 10 of the housing 2, and limits the transmission of torque generated between the housing 2 and the main damper device 4. The dynamic damper device 5 is disposed between the engine and the main damper device 4 in the axial direction. Specifically, the dynamic damper device 5 is disposed between the housing 2 on the engine side and the main damper device 4 in the axial direction. More specifically, the main damper device 5 is disposed between the first cover 9 of the housing 2 and the main damper device 5 in the axial direction. Even if configured as such, the same effect as the above exemplary embodiment can be obtained.

(d) The main damper device 4 of the aforementioned exemplary embodiment is shown as an example of the main damper device 4; the configuration of the main damper device 4 can be configured in any way.

For example, the main damper device 4 can be configured in any way as long as the configuration thereof includes the drive plate 13 coupled to the housing 2, the driven plate 14 which is disposed so as to be relatively rotatable with respect to the drive plate 13 and is coupled to the output hub 3, and at least one coil spring 15 for elastically coupling the drive plate 13 and the driven plate 14.

(e) The dynamic damper device 5 of the aforementioned exemplary embodiment is shown as an example of the dynamic damper device 5; the configuration of the dynamic damper device 5 can be configured in any way.

For example, the dynamic damper device 5 can be configured in any way as long as the configuration thereof includes the damper plate part 50 to which torsional vibration output from the main damper device 4 is input, the inertia part 51 configured to be relatively movable with respect to the damper plate part 50, and at least one damper spring 52 for elastically coupling damper plate part 50 and the inertia part 51.

(f) The dynamic damper device 5 of the aforementioned exemplary embodiment is shown as an example of a dynamic vibration absorbing device; the configuration of the dynamic damper device 5 can be configured in any way.

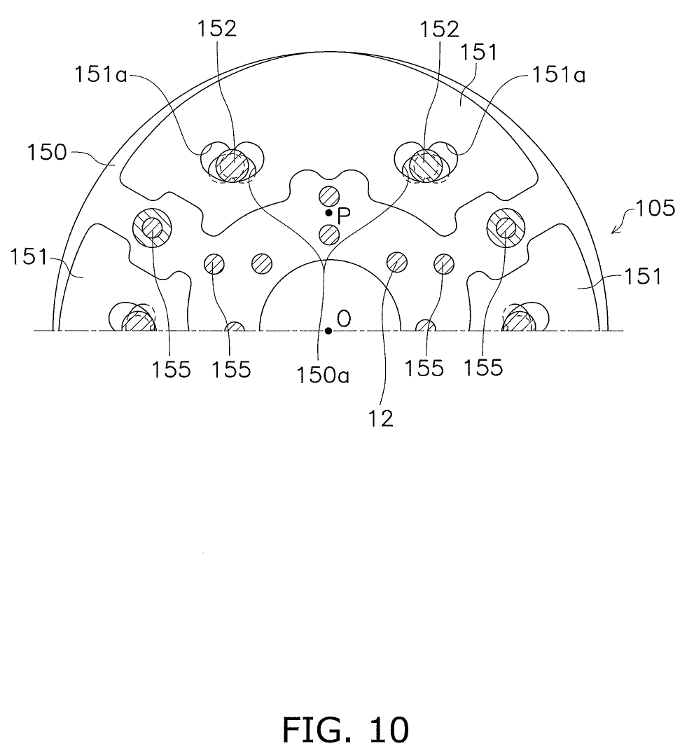

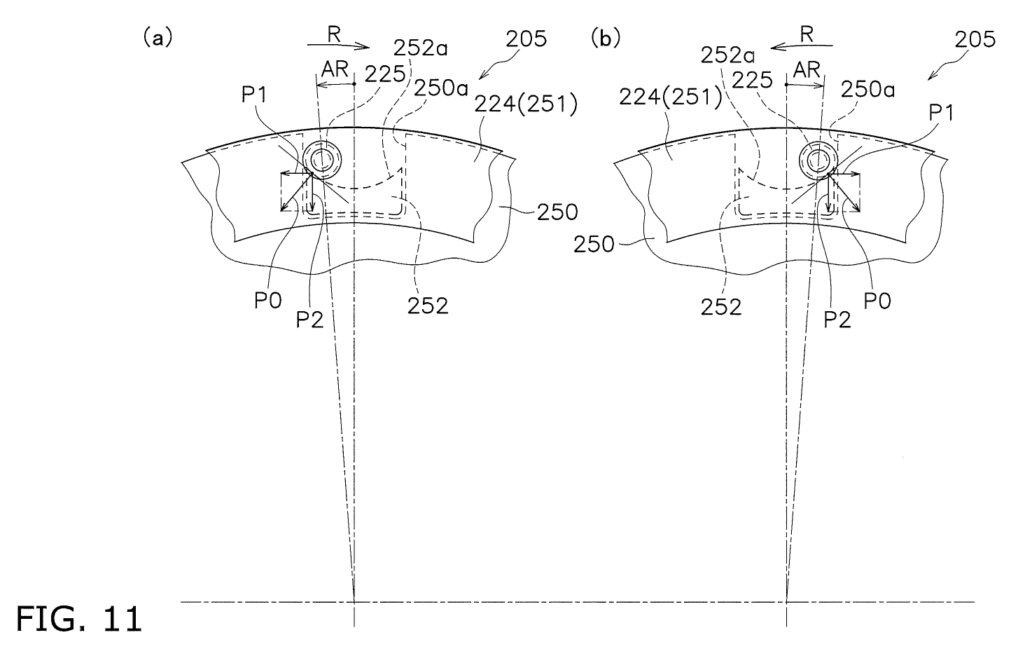

For example, as shown in FIG. 10, a configuration can be adopted in which a dynamic damper device 105 is constituted. In this case, the dynamic damper device 105 includes a pair of damper plate parts 150 and a plurality of inertia parts 151. One of the damper plate parts 150 is fixed to the output hub 3 (the second hub flange 3b) by the plurality of rivets 12. The other of damper plate parts 150 (not shown) is disposed so as to face one of the damper plate parts 150 in the axial direction, and is fixed to one of the damper plate parts 150 by a plurality of rivets 155.

Each of the plurality of inertia parts 151 is disposed between the pair of damper plate parts 150 in the axial direction and is supported so as to be pivotable with respect to the pair of damper plate parts 150. Specifically, each of the plurality of inertia portion 151 is pivotably supported by the pair of damper plate parts 150 using the plurality of pin members 152 (for example, two).

The pin members 152 are respectively inserted through the first elongated holes 150a of the pair of damper plate parts 150 and the second elongated holes 151a of the inertia part 151. The central part of the first elongated hole 150a has a bulge shape toward the outer peripheral side and is formed in a substantially circular arc shape. The central part of the second elongated hole 151a has a bulge shape toward the inner peripheral side and is formed in a substantially circular arc shape.

In this configuration, when the torsional vibration from the main damper device 4 is transmitted to the dynamic damper device 105, each of the inertia parts 151 pivots with respect to the damper plate part 150 via the pin member 152.

In this case, a pivot center P of each of the inertia parts 151 is provided farther radially outward than the rotational axis O. Each of the inertia parts 151 pivots with respect to the damper plate part 150 with reference to the pivot center P.

More specifically, each of the inertia parts 151 pivots with reference to the pivot center P so as to suppress the rotation of the damper plate part 150. With this configuration, the torsional vibration is absorbed by the dynamic damper device 105.

(g) The dynamic damper device 5 of the aforementioned exemplary embodiment is shown as an example of a dynamic vibration absorbing device; the configuration of the dynamic damper device 5 can be configured in any way.

For example, as shown in FIG. 11, a configuration can be adopted in which a dynamic damper device 205 is configured. In this case, the dynamic damper device 205 includes a damper plate part 250, an inertia part 251 (for example, a pair of inertia), and a plurality of centrifugal elements 252. The damper plate part 250 is fixed to the output hub 3 (the second hub flange 3b) by the plurality of rivets 12 (refer to FIGS. 2 and 3).

The inertia part 251 is configured to be relatively rotatable with respect to the damper plate part 250. The inertia part 251 includes a pair of inertia rings 224 and a pin member 225 for coupling the pair of inertia rings 224. The damper plate part 250 is disposed between the pair of inertial rings in the axial direction.

The centrifugal element 252 is engaged with the inertia part 251 by the centrifugal force. The centrifugal element 252 guides the inertia part 251 so that the relative displacement between the damper plate part 250 and the inertia part 251 is reduced.

Specifically, each of the centrifugal members 252 is disposed in each of the plurality of recess parts 250a of the damper plate part 250 so as to be movable in the radial direction by the centrifugal force. A cam surface 252a is formed on the radially outer surface of each of the centrifugal elements. Each of the pin members 225 can abut on each of the cam surfaces 252a. In a state in which each pin member 225 abuts with each cam surface 252a, each pin member 225 is movable along each cam surface 252a.

It should be noted that each of the pin members 225 includes a shaft part whose both end parts are respectively fixed to each of the pair of inertia parts 251, and a roller part that is rotatable around the shaft part. Here, the roller part is in contact with the cam surface 252a.

In this configuration, as shown in FIG. 11A, when each centrifugal element 252 moves radially outward by the centrifugal force, the cam surface 252a of each centrifugal 252 abuts on each pin member 225. When the torsional vibration from the main damper device 4 is transmitted to the dynamic damper device 205 in this state, as shown in FIG. 11B, the inertia part 251 (the pair of inertia rings 224) relatively moves in the circumferential direction with respect to the damper plate part 250. At this time, while each centrifugal member 252 moves radially inward, each pin member 225 moves along the cam surface 252a of each of the centrifugal members 252 in the rotational direction (opposite direction AR) opposite to the rotational direction of the damper plate part 250. That is, the inertia part 251 (the pin member 225) moves in the opposite direction AR.

At this time, each pin member 225 presses the cam surface 252a of each centrifugal element 252. For example, a pressing force P0 in FIG. 11B acts on the cam surface 252a of each centrifugal element 252 from each pin member 225. Then, the damper plate part 250 (each centrifugal member 252) is pulled back in the above-mentioned opposite direction AR by a component force P1 of the pressing force P0. Thus, each centrifugal element 252 guides the inertia part 251 so that the relative displacement between the damper plate part 250 and the inertia part 251 is reduced. In other words, the inertia part 251 suppresses the rotation of the damper plate part 250 via each centrifugal member 252. With this configuration, the torsional vibration is absorbed by the dynamic damper device 205.

### REFERENCE SIGNS LIST

1 Vibration reduction device
2 Housing
3 Output hub
4 Main damper device
5 Dynamic damper device
8 Torque limiter
13 Drive plate
14 Driven plate
15 Coil spring
21 First coupling plate
22 Second coupling plate
23 Friction member
24 Cone spring
50 Damper plate part
51 Inertia part
52 Damper spring
S Internal space
O Rotational axis

1. A vibration reduction device for reducing a torsional vibration from an engine, the vibration reduction device comprising:
an input rotary part to which the torsional vibration is input;
an output rotary part disposed to be relatively rotatable with respect to the input rotary part;
a damper part that is disposed between the input rotary part and the output rotary part and attenuates the torsional vibration input to the input rotary part;
a dynamic vibration absorbing device for absorbing the torsional vibration output from the damper part; and
a torque limiting part for limiting transmission of torque between the input rotary part and the output rotary part.

2. The vibration reduction device according to claim 1, wherein
the input rotary part constitutes an internal space capable of containing lubricating oil, and
the damper part, the torque limiting part, and the dynamic vibration absorbing device are disposed in the internal space.

3. The vibration reduction device according to claim 1, wherein
the torque limiting part is disposed between the input rotary part and the damper part.

4. The vibration reduction device according to claim 3, wherein
the torque limiting part includes
a first coupling member coupled integrally rotatable to the input rotary part,
a second coupling member coupled integrally rotatable to the damper part, and
a first friction member held between the first coupling member and the second coupling member.

5. The vibration reduction device according to claim 4, wherein
the second coupling member is coupled to the damper part so as to be movable in a direction along a rotational axis of the input rotary part.

6. The vibration reduction device according to claim 1, wherein
the torque limiting part is disposed between the damper part and the output rotary part.

7. The vibration reduction device according to claim 6, wherein
the torque limiting part includes
a third coupling member disposed spaced apart from the output rotary part and coupled integrally rotatable to the output rotary part, and
a second friction member that is held between the damper part and at least either the output rotary part or the third coupling member.

8. The vibration reduction device according to claim 1, wherein,
when the torque is less than a predetermined torque, the torque limiting part transmits the torque between the input rotary part and the output rotary part, and,
when the torque is equal to or greater than the predetermined torque, the torque limiting part substantially cancels the transmission of the torque between the input rotary part and the output rotary part.

9. The vibration reduction device according to claim 1, wherein
the dynamic vibration absorbing device is disposed side by side with the damper part in the direction along the rotational axis of the input rotary part.

10. The vibration reduction device according to claim 1, wherein
the damper part includes
a first rotary member coupled to the input rotary part,
a second rotary member disposed relatively rotatable with respect to the first rotary member and coupled to the output rotary part, and
a first elastic member that elastically couples the first rotary member and the second rotary member to each other.

11. The vibration reduction device according to claim 1, wherein
the dynamic vibration absorbing device includes
an input member to which the torsional vibration output from the damper part is input, and
an inertia mass body configured to be relatively movable with respect to the input member.

12. The vibration reduction device according to claim 11, wherein
the dynamic vibration absorbing device further includes a second elastic member that elastically couples the input member and the inertia mass body to each other.

13. The vibration reduction device according to claim 11, wherein
each of a plurality of inertia mass bodies is pivotably supported by the input member with reference to a pivot center that is farther radially outward than the rotational axis of the input rotary part.

14. The vibration reduction device according to claim 11, wherein
the dynamic vibration absorbing device further includes a centrifugal element for engaging with the inertia mass body by a centrifugal force and guiding the inertia mass body so that a relative displacement between the input member and the inertia mass body is reduced.
